(19) United States
(12) Patent Application Publication
(10) Pub. No.: US 2002/0083063 A1
(43) Pub. Date: Jun. 27, 2002

(54) Software and data processing system with priority queue dispatching

(75) Inventor: David A. Egolf, Glendale, AZ (US)

Correspondence Address: John S. Solakian Esq., Law Office - M/S B55, Bull HN Information Systems Inc., 13430 North Black Canyon Highway, Phoenix, AZ, 85029-1310, US

(73) Assignee: Bull HN Information Systems Inc.

(21) Appl. No.: 09/748,404

(22) Filed: Dec. 26, 2000

(51) Int. Cl. G06F 17/00; G06F 9/00

(52) U.S. Cl. 707/100

(57) ABSTRACT

A dispatcher in a multiprogramming or multitasking operating system in a data processing system selects the next task to be executed by an available processor. Access to shared resources are controlled by locks and queues, where tasks are queued when they find the shared resource locked, and dequeued one by one as the lock is unlocked. When a lock is unlocked, the first task in a FIFO queue is dispatched with a temporary priority at least as high as any in the queue. This first task must retain this temporary urgency until it releases the resource or until its urgency is further increased due to the addition of a higher priority task to the resource queue or a dependent resource queue. This prevents starvation of higher priority tasks waiting in the FIFO queue.

### FIELD OF THE INVENTION

The present invention generally relates to data processing system operating system software, and more specifically to a dispatcher in such operating system software.

### BACKGROUND OF THE INVENTION

A data processing system comprises one or more computer processors plus their peripheral and support devices. Operation of a data processing system is controlled by an operating system. In a multiprogramming or multitasking operating system, work units, such as tasks, activities, jobs, and threads (hereinafter “tasks”), are scheduled and/or dispatched for execution by a portion of the operating system termed the dispatcher or scheduler (hereinafter, the “dispatcher”).

Access to shared resources in a data processing system is typically controlled by locks and queues. One task locks a lock controlling a shared resource, then accesses the shared resource. Upon completion of its access to that shared resource, that task unlocks the lock. Tasks arriving at the lock while locked typically enter into a queue. When the task that has locked the lock unlocks it, and one or more tasks are in the queue for the lock, one (or more) of the tasks in the queue is activated and dequeued from the queue so that that task can take its turn locking the resource.

The specifics of how this dequeueing is done varies by operating system and even within operating systems, depending on what type of resource is being serialized. In one case, in a multiprocessor system, instead of entering a queue, processors keep trying the lock until they finally find it unlocked and can lock it themselves. If failing to lock the lock does not cause an interrupt, these are termed “spin locks”. They are typically restricted to critical operating system functions of very short duration. In the case where an interrupt occurs when the task fails to lock a lock, the task may be placed in a queue, or may just be redispatched later. One problem with the later is that unless few tasks are competing for a resource, the redispatching can be costly and inefficient.

When tasks try to lock a lock and fail and are placed in a queue, they can be redispatched in a number of orders. For example, the highest priority task may be the task dispatched when the lock is unlocked. However, this often leads to starvation of lower priority tasks. Alternatively, the tasks can be dispatched in a First In-First Out (FIFO) order. This prevents starvation of lower priority tasks.

However, this queuing methodology can cause severe problems in certain situations. For example, if the first task in the queue has a sufficiently low priority, then it may never be selected for a dispatch. This is not really a problem unless there are higher priority tasks behind it in the FIFO queue. In that case, these higher priority tasks in the queue may be starved. This is termed a “Priority Inversion” problem. Upon investigation, it turned out that this situation was the cause of the recent failure of one of NASA's Mars missions.

One solution found in many Unix systems is to activate all of the tasks in a resource queue. The system dispatcher will then select the task with the highest priority which will ultimately end up locking the lock and acquiring the shared resource. The other tasks will either acquire the lock by the time they are dispatched, or will find the lock locked and will put themselves back to sleep.

While this effectively eliminates the “Priority Inversion” problem, it does so at a high cost in terms of resources utilized in solving the problem as each task attempting to lock the lock over the shared resource must be dispatched, just to be requeued if it finds the lock again locked. This technique also violates the desired FIFO ordering of the queue, resulting in potential starvation of low priority tasks.

It would thus be advantageous to find a solution to both the above mentioned Priority Inversion problem without the overhead and low priority task starvation found in most Unix solutions.

### BRIEF DESCRIPTION OF THE DRAWINGS

The features and advantages of the present invention will be more clearly understood from the following detailed description taken in conjunction with the accompanying FIGURES where like numerals refer to like and corresponding parts and in which:

FIG. 1 is a block diagram illustrating a General Purpose Computer 20 in a data processing system;

FIG. 2 is a block diagram illustrating an example of queue of tasks awaiting ownership of a shared resource controlled by a lock;

FIG. 3 is a block diagram illustrating assignment of a temporary dispatching priority to queue members, in accordance with a preferred embodiment of the present invention;

FIG. 4 is a flowchart illustrating operation of a task attempting to lock a lock, in accordance with a preferred embodiment of the present invention;

FIG. 5 is a flowchart illustrating operation of a task unlocking a lock, in accordance with a preferred embodiment of the present invention; and

FIG. 6. is a flow chart illustrating partial operation of a dispatcher, in accordance with the present invention.

### DETAILED DESCRIPTION

A dispatcher in a multiprogramming or multitasking operating system in a data processing system selects the next task to be executed by an available processor. Access to shared resources are controlled by locks and queues, where tasks are queued when they find the shared resource locked, and dequeued one by one as the lock is unlocked. When a lock is unlocked, the first task in a FIFO queue is dispatched with a temporary priority at least as high as any in the queue. This first task must retain this temporary urgency until it releases the resource or until its urgency is further increased due to the addition of a higher priority task to the resource queue or a dependent resource queue. This prevents starvation of higher priority tasks waiting in the FIFO queue.

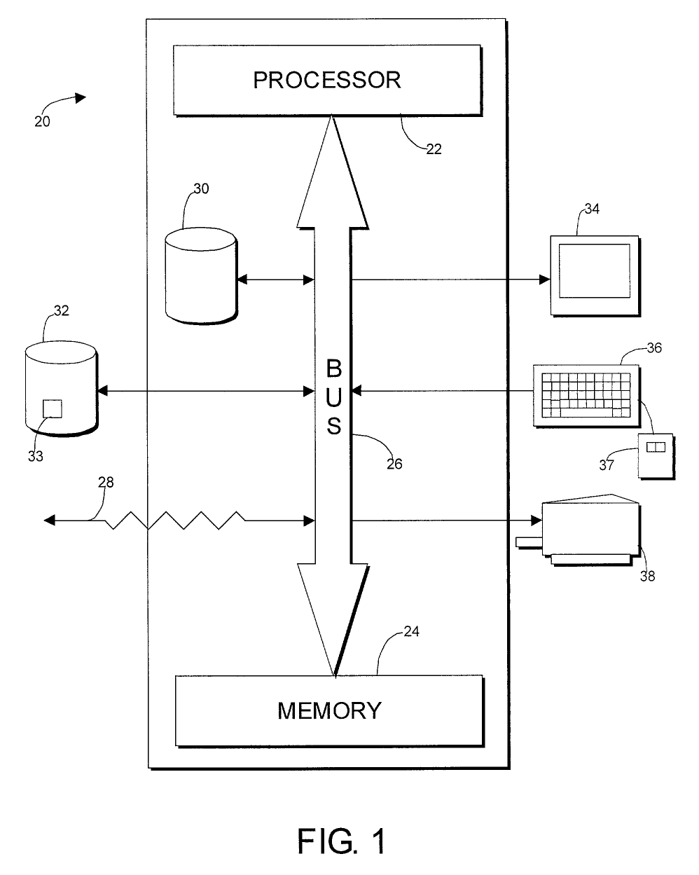

FIG. 1 is a block diagram illustrating a General Purpose Computer 20 in a data processing system. The General Purpose Computer 20 has a Computer Processor 22, and Memory 24, connected by a Bus 26. Memory 24 is a relatively high speed machine readable medium and includes Volatile Memories such as DRAM, and SRAM, and Non-Volatile Memories such as, ROM, FLASH, EPROM, and EEPROM. Also connected to the Bus are Secondary Storage 30, External Storage 32, output devices such as a monitor 34, input devices such as a keyboard 36 (with mouse 37), and printers 38. Secondary Storage 30 includes machine-readable media such as hard disk drives (or DASD). External Storage 32 includes machine-readable media such as floppy disks, removable hard drives, magnetic tape, CD-ROM, and even other computers, possibly connected via a communications line 28. The distinction drawn here between Secondary Storage 30 and External Storage 32 is primarily for convenience in describing the invention. As such, it should be appreciated that there is substantial functional overlap between these elements. Computer software such as data base management software, operating systems, and user programs can be stored in a Computer Software Storage Medium, such as memory 24, Secondary Storage 30, and External Storage 32. Executable versions of computer software 33, can be read from a Non-Volatile Storage Medium such as External Storage 32, Secondary Storage 30, and Non-Volatile Memory and loaded for execution directly into Volatile Memory, executed directly out of Non-Volatile Memory, or stored on the Secondary Storage 30 prior to loading into Volatile Memory for execution.

Operation and control of data processing systems are typically controlled by an operating system. Operating systems may be single user or multi-user. As they become more sophisticated, they tend to be multi-tasking and/or multi-programming, simultaneously supporting multiple execution units, such as tasks, activities, jobs, and threads (hereinafter “tasks”).

Tasks are scheduled and dispatched for execution on a processor by a portion of the operating system termed here the “dispatcher” (also called in some systems the “scheduler”). Tasks typically execute until interrupted, either by a timer, or by some other interrupt, or they voluntarily give up control of the processor to the operating system, at which time another task is dispatched. Typically, the selection of which task to dispatch is determined on a priority basis, with each task having a priority. Higher priority tasks are typically dispatched before lower priority tasks. These priorities may be fixed, or may vary through time. The complexity of such a dispatching priority scheme varies among operating systems, ranging from fairly simple, to extremely complex. One example of a dynamic dispatching priority scheme is found in the OS/2200 operating system from Unisys where I/O bound tasks are given increasing priority. Another example is found in the GCOS 8 operating system from Bull where tasks are grouped by class, and dispatching priority for a class is adjusted dynamically to meet specified class performance goals and quotas.

Another function of a modern operating system is to provide to programs (including the operating system itself) the ability to serialize access to resources shared among a plurality of tasks. In higher performance operating systems, this is often done through the use of locks and queues, with tasks entering a queue when they find a lock locked. In the case of a FIFO queue, the first task in the queue is activated for dispatch by the dispatcher when the lock is unlocked by another task. When dispatched, this newly dispatched task will then typically lock the lock, access the shared resource, then unlock the lock, resulting in activation of the next task in the queue.

Here we define a “critical” section of code or execution to exist for a task between the time that it has attempted to lock a lock protecting a shared resource, and when it ultimately unlocks that lock. Note that usage of shared resources, and thus use of the corresponding locks, can be embedded. Thus, a task may lock one lock controlling access to one shared resource, then attempt to lock a lock for another shared resource. This sort of embedded locking must be done carefully in order to prevent deadly embracing between two or more tasks. Herein, the term “critical” section shall mean when any task currently has a lock locked, or is in a queue for any lock.

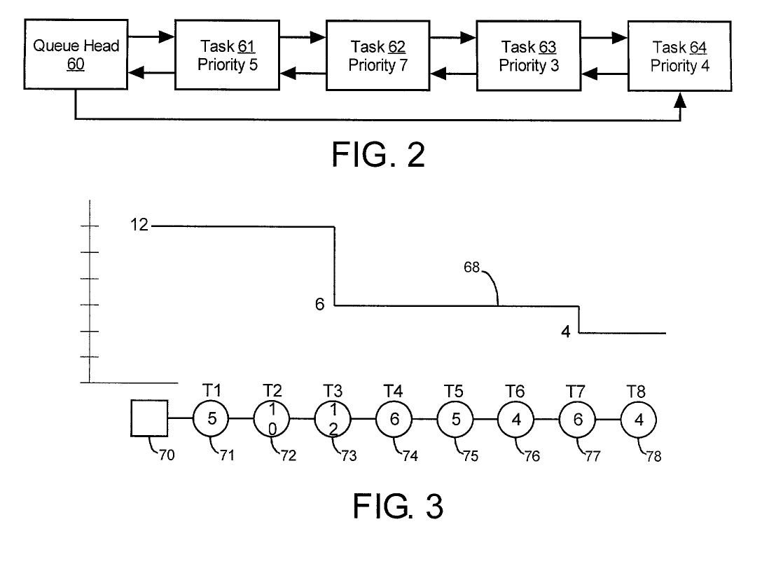

FIG. 2 is a block diagram illustrating an example of queue of tasks awaiting ownership of a shared resource controlled by a lock. The example queue is a doubly linked FIFO queue with a queue head 60 pointing at the first task in the queue 61 and the last task in the queue 64. The example queue consists of four tasks 61, 62, 63, 64 chained in a First In/First Out (FIFO) order. The first task 61 has a dispatch priority of “5”. The second task 62 has a dispatch priority of “7”. The third task 63 has a dispatch priority of “3”. The fourth task 64 has a dispatch priority of “4”. In the present invention, when the lock corresponding to the queue is unlocked, the first task 61 in the queue is activated for dispatch. When dispatched, it is dispatched with a temporary dispatching priority of at least “7”, which is the maximum of (5, 7, 3, and 4). When that first task 61 unlocks the lock, and if no more tasks have entered the queue by that time, finding the lock locked, the second task 62 will also be dispatched with a temporary dispatching priority of at least 7. However, when the third task 63 is dispatched, assuming that no other tasks have entered the queue, it is dispatched with a temporary dispatching priority of at least 4, as is the fourth task 64.

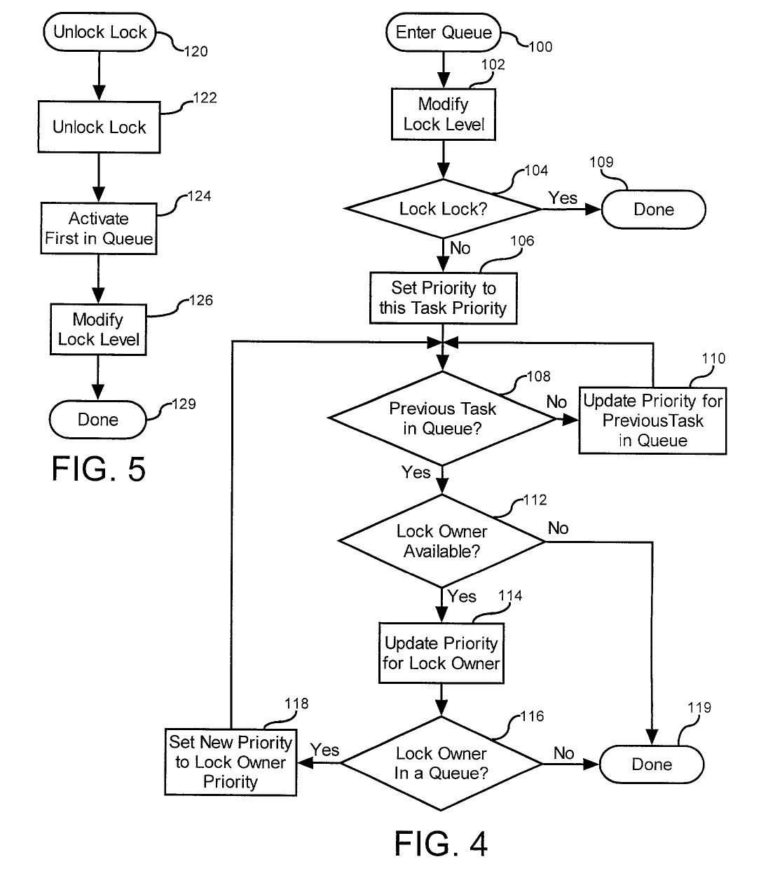

It should be noted that a doubly linked FIFO queue is shown. Each task has a forward link to the next task in the queue, as well as a backward link to the previous task in the queue. One reason for a doubly linked FIFO queue will be seen in FIG. 4. However, FIFO queues are often only linked in a forward direction. Such a queue structure is also within this invention.

In the preferred and a first alternate embodiments of the present invention, the determination of the temporary dispatching priority is determined to be at least as high as any tasks in the queue. In the first alternate embodiment, a highest priority value is maintained for the queue. Then, whenever a task is enqueued on the queue, its priority is compared to the highest priority value for that queue, and if higher, the task's priority replaces the previous highest priority value for the queue. Then, whenever a task releases the resource by unlocking the lock, the remainder of the queue is searched for the highest task priority, and the highest priority value for the queue is adjusted accordingly.

In a second alternate embodiment, the temporary dispatch priority is set to a fixed value. In a first implementation of this embodiment, the temporary dispatch priority is set to a value that is the highest possible in the data processing system. In a second implementation of this embodiment, it is set to a specified value for the data processing system. This value may be set by the operating system vendor or when the operating system is configured, or may be dynamically modified, for example by system operator command. This may be appropriate if the operating system can guarantee that tasks with this priority will receive a timely dispatch. In a third alternate embodiment, each shared resource queue, or group of shared resource queues, has a specified temporary dispatch priority value. This specified temporary dispatch priority value for the queue or group of queues may again be set by the operating system vendor, may be specified at system configuration time, or may be dynamically modified.

One advantage of the preferred and first alternate embodiments, where the temporary dispatch priority value is dynamically set based on the priority of the tasks in the shared resource queue, is that the additional priority given tasks being dispatched after the unlock of a lock is minimized, thereby minimizing the impact of this invention on the remainder of the data processing system. One advantage of the second and third alternative embodiments where the temporary dispatch priority is set to a specified value is that it minimizes the amount of dispatcher code that needs to be executed to implement this invention.

FIG. 3 is a block diagram illustrating assignment of a temporary dispatching priority to queue members, in accordance with a preferred embodiment of the present invention. An example FIFO queue has a queue head 70 followed by eight tasks: T1 71 with a priority of “5”; T2 72 with a priority of “10”; T3 73 with a priority of “12”; T4 74 with a priority of “6”; T5 75 with a priority of “5”; T6 76 with a priority of “4”; T7 77 with a priority of “6”; and T8 78 with a priority of “4”. Along a horizontal axis, parallel to the queue, is a bar graph 68 showing the temporary dispatch priority of the tasks in the queue. Tasks T1 71, T2 72, and T3 73 will dispatch with a temporary dispatch priority of at least “12”. After task T3 73 releases the resource, the highest priority in the queue is now “6”. Thus, tasks T4 74, T5 75, T6 76, and T7 77 are dispatched with a temporary dispatch priority of at least “6”, which is the standard dispatch priority of task T7 77. Finally, the only task remaining in the queue is task T8 78, with a standard dispatch priority of “4”, which is also the temporary dispatch priority for this task.

If a ninth task, T9 (not shown), enters at the end of the FIFO queue with a standard dispatching priority of “7”, before task T1 71 is dispatched, the temporary dispatching priority for tasks T4 74, T5 75, T6 76, T7 77, and T8 78 will be accordingly set to “7”. The temporary dispatching priority for tasks T1 71, T2 72, and T3 73 remains “12” as this is larger than the standard dispatching priority of task T9 of “7”.

In the preferred embodiment, a pointer is maintained at the queue head to the task that has locked the corresponding lock. This pointer is used to update the temporary dispatching priority of the task that has the lock locked to correspond to the greatest dispatching priority of any tasks in the queue. Thus, whenever a task enters a queue with a dispatching priority higher than some tasks in the queue, the temporary dispatching priority for each of the tasks ahead of that task in the queue, plus the task with the lock locked, are compared to the dispatching priority of the newly entered task, and the temporary dispatching priority for these other tasks are updated accordingly to this new dispatching priority if it is higher.

In some situations, locks and queues may be embedded within the use of other locks. This is a common occurrence in many multiprocessing operating systems. In such a situation, in the preferred embodiment, when updating the temporary dispatching priority for tasks when a task enters a first queue after finding a lock locked, the task having locked the corresponding lock is checked to see if it is queued in a second queue. If so, all of the tasks ahead of it in that second queue, including the task having the corresponding lock locked, have their temporary dispatching priority updated accordingly. This is done recursively through a third, fourth, etc. queues, if necessary.

In a first implementation of the preferred embodiment, each task has a push down stack for identification of queues for which it is either attempting to lock, or has already locked. Whenever the push down stack is empty, the standard task priority is utilized for dispatching. Whenever the push down stack is non-empty, the task is in a critical section, and the temporary dispatching priority is utilized whenever the task is dispatched. In a second implementation, a counter is incremented for each task whenever it attempts to lock a lock protecting a shared resource, and is decremented whenever it unlocks such a lock. Then, whenever the counter is zero, the standard task priority is utilized for dispatching that task. Whenever the counter is greater than zero, the task is in a critical section, and the temporary dispatching priority is utilized whenever the task is dispatched. In either implementation, whenever a task enters a critical section, its temporary dispatching priority is set to its standard dispatching priority.

FIG. 4 is a flowchart illustrating operation of a task attempting to lock a lock, in accordance with a preferred embodiment of the present invention. Upon attempting to lock a lock protecting a shared resource, step 100, the lock level for this task is modified, step 102. As noted above, in one embodiment, this is done by use of a push down stack. In another embodiment, this is done by incrementing a lock level index for that task. If this is the first level of locking, the temporary dispatching priority for the task is set to the current or standard dispatch priority for that task. Whenever a task is dispatched with this lock level index greater than zero (if incremented) or non-null (if pushed), the task is dispatched with its dispatch priority at least as high as its temporary dispatching priority instead of with its current or standard dispatch priority. An attempt is then made to lock the lock, step 104. If successful, the task exits the locking logic, step 109.

Otherwise, the task is placed at the end of the queue for the lock (not shown). The current temporary dispatching priority is then set to the temporary dispatching priority of the task just queued, step 106, and an outer loop is entered. The queue is scanned in a reverse direction, forming an inner loop, moving from the latest task in the queue, to the first task in the queue. A check is made whether there is a previous task in the queue, step 108. If there is a previous task in the queue, step 108, its temporary dispatching priority is compared to the current temporary dispatching priority, and if lower, is set to the current temporary dispatching priority, step 110. This inner loop then repeats until no more tasks remain in the queue, step 108.

Note here that a reverse processing order for the queue is utilized. While a reverse processing order is conceptually preferable to a forward processing order, sometimes lock queues are only linked in a forward direction. In such a case, a forward processing of the queue may be utilized, stopping the processing in the inner loop when the task is encountered from which the current temporary dispatching priority was obtained.

One additional feature is that in the case where the queue is searched from tail to front setting the temporary priority, the search through the preceding tasks in the queue can be terminated as soon as a task is encountered whose priority is at least as high as that of the task being inserted.

When the queue is exhausted, step 108, the inner loop is exited, a test is made whether there is currently an owner to the lock, and if that owner is available, step 112. If the owner to the lock (e.g. the task that locked the lock) can not be ascertained, step 108, the lock processing is complete, step 119.

Otherwise, if the owner to the lock can be ascertained, step 108, that task's temporary dispatching priority is compared to the current temporary dispatching priority and is updated if lower, step 114. Thus, the temporary dispatching priority for each task in the queue ahead of the task providing the current temporary dispatching priority is set to a maximum of its own temporary dispatching priority and the current temporary dispatching priority.

Then, the lock owner is tested to see if it is currently waiting in another queue, step 116. If it is not currently in a queue, step 116, the lock processing is complete, step 119. Otherwise, the current temporary dispatching priority is set to the temporary dispatching priority of the lock owner, and the outer loop is reentered, starting at step 108, processing the tasks ahead of that task in the second (or subsequent) queue and updating their temporary dispatching priority to the current temporary dispatching priority, if lower, step 110. The temporary dispatching priority of the lock owner for that second (and subsequent) task is also compared to the current temporary dispatching priority, and updated if necessary, step 114. This outer loop repeats until no more embedded locks are found.

FIG. 5 is a flowchart illustrating operation of a task unlocking a lock, in accordance with a preferred embodiment of the present invention. The task starts the unlocking of a lock, step 120, by first unlocking the lock, step 122. The priority of the queue is reduced to the temporary priority of the first waiting process. The first task in the queue is then activated for dispatch, step 124. The lock level of the process is modified, step 126, and the task locking operation is then complete, step 129. When the lock level of the process is modified, the priority stack in the process is popped up. If the process had been participating in another resource lock, then the temporary priority of the process is restored to the current priority of that queue. Note that when locks are nested, the temporary priority of a process can be increased due to a higher priority task waiting behind it in the inner lock. The lock level stack mechanism allows the task to revert to the appropriate priority level as soon as it releases the inner lock.

The lock level stack mechanism requires both a task level push down stack which keeps track of each resource queue controlling each held lock. It also requires that the queues maintain their own value of the current queue priority in a static variable. In an alternative embodiment, the temporary dispatch priority of the first waiting process can be used instead of a static queue variable.

Note that other orderings of these steps are within the scope of this invention and may be required to implement this invention in different computer architectures.

In the present invention, the first task in a FIFO queue is activated with a potentially higher temporary priority when being activated for dispatch after the corresponding lock is unlocked. This provides a mechanism for preventing processor time starvation of higher priority tasks later in the shared resource queue. In a preferred embodiment, the higher temporary dispatching priority is at least as high as the highest priority of any task in the shared resource queue.

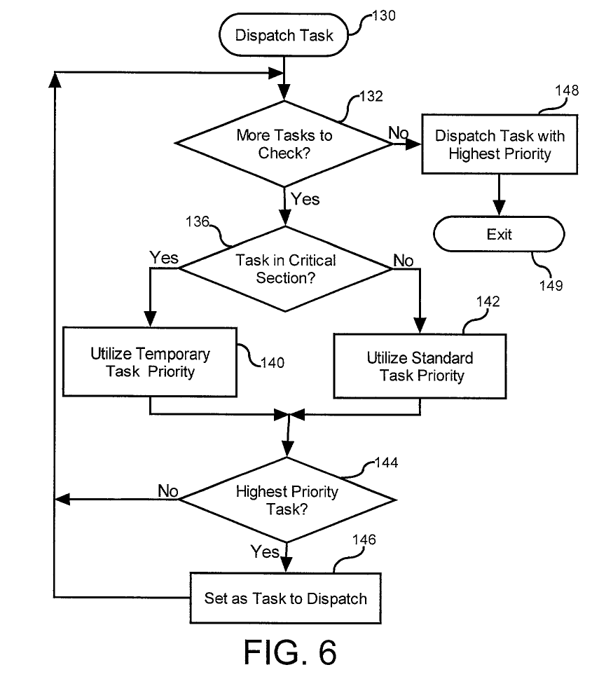

FIG. 6. is a flow chart illustrating partial operation of a dispatcher, in accordance with the present invention. Upon entering the dispatcher, step 130, a loop is entered to search through all tasks eligible for dispatch. While there are more tasks to check, step 132, the next task to be checked is tested to see if it is in a critical section, step 136. As noted above, a task is in a critical section when it has either one or more locks locked, or is in a queue awaiting the chance to lock a lock. If the task is determined to be in a critical section, step 136, the temporary task priority is utilized as its dispatching priority, step 140. Otherwise, the standard task priority is utilized as its dispatching priority, step 142. The task priority determined in steps 140 or 142 is then compared to the current highest priority. If this new task priority is higher than the previous highest task priority, step 144, this task is set to be the task dispatched, step 146. Regardless, the loop is then repeated, checking for another task that is eligible for being dispatched, step 132. When there are no more tasks eligible for dispatch, the task with the highest priority, as determined in steps 140, 142, 144, and 146, is dispatched, step 148. The dispatcher then exits, step 149. Note that a typical dispatcher performs other functions. This FIG. is illustrative only and includes only those steps that are related to this invention.

While the dispatcher in this FIG. is described in terms of searching through a list of tasks for the next task to dispatch, in the preferred embodiment, as in most modem operating systems, an actual search of the queues of tasks ready for dispatch is extremely costly in terms of processor cycles. Instead, the tasks eligible for dispatch are usually kept in a queue ordered by priority. Whenever a task ready for dispatch has its temporary priority increased as a result of the enqueuing of another task in the dispatch queue, that task is removed from the appropriate dispatch queue, and is then reinserted at the proper place for that priority.

One subtlety needs further elaboration here. In the alternative embodiments, the temporary dispatching priority is set for a task when it is activated for dispatch when it is the first task in a FIFO queue and the task that had locked the corresponding lock unlocks it. This priority is then utilized when the task is ultimately dispatched. In the preferred embodiment, the actual dispatch of any task within a critical section (i.e. within the outermost locking of locks) is done at last at a priority as high as, if not higher than, the temporary dispatching priority of that task being dispatched. The difference here is that in the preferred embodiment, the temporary dispatching priority may change between the time that a task is activated for dispatch, and the time that it is actually dispatched. Also note that a task may be dispatched multiple times within the critical section, and that the temporary dispatching priority for that task is dynamically adjusted as other tasks attempt to lock locks protecting shared resources. The resulting difference is that the alternative embodiments significantly reduce, but may not totally eliminate, the priority inversion problem, whereas the preferred embodiment can be guaranteed to eliminate that problem. However, this surety is garnered at a higher cost in both processor resources and in programming complexity.

The present invention prevents starving of processor resources for higher priority tasks by lower priority tasks in a shared resource FIFO queue by activating tasks after unlock of the lock corresponding to the queue with a temporary dispatch priority at least as high, if not higher, than any tasks currently remaining in the queue. Implementation of this invention therefore solves performance problems introduced by sharing a FIFO shared resource queue among tasks with different dispatching priorities, and prevents the Priority Inversion type of system failure that resulted in the loss of the Mars lander.

Those skilled in the art will recognize that modifications and variations can be made without departing from the spirit of the invention. Therefore, it is intended that this invention encompass all such variations and modifications as fall within the scope of the appended claims.

Claim elements and steps herein have been numbered and/or lettered solely as an aid in readability and understanding. As such, the numbering and/or lettering in itself is not intended to and should not be taken to indicate the ordering of elements and/or steps in the claims.

What is claimed is:

1. A method of priority queue dispatching in a data processing system, wherein:
a critical section of code for a task is when the task has at least one of a plurality of locks locked; and
said method comprises:
A) dispatching a first task for execution at a temporary dispatching priority higher than a standard dispatching priority for that first task whenever the first task is in a critical section of code for that first task, wherein the critical section of code for that first task is a result of that first task having locked a first lock without having unlocked the first lock; and
B) dispatching the first task for execution at the standard dispatching priority for that first task whenever the first task is not in the critical section of code for that first task.

2. The method in claim 1 wherein:
the method further comprises:
C) queuing a second task in a first FIFO queue when the second task attempts to lock the first lock and fails, wherein:
the FIFO queue comprises a set of tasks waiting to lock the first lock; and
step (C) comprises:
1) placing the second task at an end of the first FIFO queue;
2) comparing the temporary dispatching priority for a third task that is ahead of the second task in the FIFO queue to the temporary dispatching priority of the second task; and
3) setting the temporary dispatching priority of the third task to the temporary dispatching priority of the second task when the temporary dispatching priority of the second task is determined in substep (2) to be greater than the temporary dispatching priority of the third task.

3. The method in claim 2 wherein:
step (C) further comprises:
4) setting the temporary dispatching priority for the second task to the standard dispatching priority for the second task before substep (2) and (3).

4. The method in claim 1 wherein:
the method further comprises:
C) queuing a second task in a first FIFO queue when the second task attempts to lock the first lock and fails, wherein:
the FIFO queue comprises a set of tasks waiting to lock the first lock; and
step (C) comprises:
1) placing the second task at an end of the first FIFO queue;
2) comparing the temporary dispatching priority for the first task to the temporary dispatching priority of the second task; and
3) setting the temporary dispatching priority of the first task to the temporary dispatching priority of the second task when the temporary dispatching priority of the second task is determined in substep (2) to be greater than the temporary dispatching priority of the first task.

5. The method in claim 4 wherein step (C) further comprises:
4) testing whether the first task is in a second FIFO queue awaiting a chance to lock a second lock; and
5) upgrading the temporary dispatching priority of a third task that has a second lock locked when the first task is determined in substep (4) to be in the second FIFO queue awaiting a chance to lock the second lock, wherein substep (5) comprises:
a) comparing the temporary dispatching priority for the third task to the temporary dispatching priority of the second task; and
b) setting the temporary dispatching priority of the third task to the temporary dispatching priority of the second task when the temporary dispatching priority of the second task is determined to be greater than the temporary dispatching priority of the third task.

6. The method in claim 5 wherein:
the method further comprises:
D) comparing a highest temporary dispatching priority of any task in the first FIFO queue to the temporary dispatching priority of the first task after the first task unlocks the second lock; and
E) setting the temporary dispatching priority of the first task to the highest temporary dispatching priority of any task in the first FIFO queue when the temporary dispatching priority of the first task is determined in step (D) to be greater than the highest temporary dispatching priority of any task in the first FIFO queue.

7. The method in claim 4 wherein:
step (c) further comprises:
4) comparing the temporary dispatching priority for a third task that is ahead of the second task in the first FIFO queue to the temporary dispatching priority of the second task; and
5) setting the temporary dispatching priority of the third task to the temporary dispatching priority of the second task when the temporary dispatching priority of the second task is determined in substep (4) to be greater than the temporary dispatching priority of the third task.

8. The method in claim 1 wherein:
the temporary dispatching priority for the first task is determined dynamically and adjusted dynamically depending on the temporary dispatching priority for other tasks behind the first task in a first FIFO queue associated with the first lock.

9. The method in claim 1 wherein:
the temporary dispatching priority for the first task is a system wide value.

10. The method in claim 1 wherein:
the temporary dispatching priority for the first task is a value associated with the first lock when the first lock is a last lock that the first task has attempted to lock.

11. Software stored in a Computer Software Storage Medium for priority queue dispatching in a data processing system, wherein:
a critical section of code for a task is when the task has at least one of a plurality of locks locked; and
said software comprises:
A) dispatching a first task for execution at a temporary dispatching priority higher than a standard dispatching priority for that first task whenever the first task is in a critical section of code for that first task, wherein the critical section of code for that first task is a result of that first task having locked a first lock without having unlocked the first lock; and
B) dispatching the first task for execution at the standard dispatching priority for that first task whenever the first task is not in the critical section of code for that first task.

12. The software in claim 11 wherein:
the software further comprises:
C) queuing a second task in a first FIFO queue when the second task attempts to lock the first lock and fails, wherein:
the FIFO queue comprises a set of tasks waiting to lock the first lock; and
set (C) comprises:
1) placing the second task at an end of the first FIFO queue;
2) comparing the temporary dispatching priority for a third task that is ahead of the second task in the FIFO queue to the temporary dispatching priority of the second task; and
3) setting the temporary dispatching priority of the third task to the temporary dispatching priority of the second task when the temporary dispatching priority of the second task is determined in subset (2) to be greater than the temporary dispatching priority of the third task.

13. The software in claim 12 wherein:
set (C) further comprises:
4) setting the temporary dispatching priority for the second task to the standard dispatching priority for the second task before subset (2) and (3).

14. The software in claim 11 wherein:
the software further comprises:
C) queuing a second task in a first FIFO queue when the second task attempts to lock the first lock and fails, wherein:
the FIFO queue comprises a set of tasks waiting to lock the first lock; and
set (C) comprises:
1) placing the second task at an end of the first FIFO queue;
2) comparing the temporary dispatching priority for the first task to the temporary dispatching priority of the second task; and
3) setting the temporary dispatching priority of the first task to the temporary dispatching priority of the second task when the temporary dispatching priority of the second task is determined in subset (2) to be greater than the temporary dispatching priority of the first task.

15. The software in claim 14 wherein set (C) further comprises:
4) testing whether the first task is in a second FIFO queue awaiting a chance to lock a second lock; and
5) upgrading the temporary dispatching priority of a third task that has a second lock locked when the first task is determined in subset (4) to be in the second FIFO queue awaiting a chance to lock the second lock, wherein subset (5) comprises:
a) comparing the temporary dispatching priority for the third task to the temporary dispatching priority of the second task; and
b) setting the temporary dispatching priority of the third task to the temporary dispatching priority of the second task when the temporary dispatching priority of the second task is determined to be greater than the temporary dispatching priority of the third task.

16. The software in claim 15 wherein:
the software further comprises:
D) comparing a highest temporary dispatching priority of any task in the first FIFO queue to the temporary dispatching priority of the first task after the first task unlocks the second lock; and
E) setting the temporary dispatching priority of the first task to the highest temporary dispatching priority of any task in the first FIFO queue when the temporary dispatching priority of the first task is determined in set (D) to be greater than the highest temporary dispatching priority of any task in the first FIFO queue.

17. The software in claim 14 wherein:
set (c) further comprises:
4) comparing the temporary dispatching priority for a third task that is ahead of the second task in the first FIFO queue to the temporary dispatching priority of the second task; and
5) setting the temporary dispatching priority of the third task to the temporary dispatching priority of the second task when the temporary dispatching priority of the second task is determined in subset (4) to be greater than the temporary dispatching priority of the third task.

18. The software in claim 11 wherein:
the temporary dispatching priority for the first task is determined dynamically and adjusted dynamically depending on the temporary dispatching priority for other tasks behind the first task in a first FIFO queue associated with the first lock.

19. The software in claim 11 wherein:
the temporary dispatching priority for the first task is a system wide value.

20. The software in claim 11 wherein:
the temporary dispatching priority for the first task is a value associated with the first lock when the first lock is a last lock that the first task has attempted to lock.

21. A computer readable Non-Volatile Storage Medium encoded with software for priority queue dispatching in a data processing system, wherein:
a critical section of code for a task is when the task has at least one of a plurality of locks locked; and
said software comprises:
A) dispatching a first task for execution at a temporary dispatching priority higher than a standard dispatching priority for that first task whenever the first task is in a critical section of code for that first task, wherein the critical section of code for that first task is a result of that first task having locked a first lock without having unlocked the first lock; and
B) dispatching the first task for execution at the standard dispatching priority for that first task whenever the first task is not in the critical section of code for that first task.
